(19) United States
(12) Patent Application Publication
(10) Pub. No.: US 2026/0153451 A1
(43) Pub. Date: Jun. 4, 2026

(54) OPTICAL-TYPE FOREIGN MATTER INSPECTION DEVICE

(71) Applicant: Hitachi High-Tech Corporation, Minato-ku, Tokyo (JP)

(72) Inventors: Tomoharu NAGASHIMA, Tokyo (JP); Hisaaki KANAI, Tokyo (JP); Masami MAKUUCHI, Tokyo (JP); Kazuma OGAWA, Tokyo (JP); Masaya YAMAMOTO, Tokyo (JP)

(21) Appl. No.: 19/123,241

(22) PCT Filed: Dec. 19, 2022
(86) PCT No.: PCT/JP2022/046677

§ 371 Date: Apr. 22, 2025

(51) Int. Cl. G01N 21/956; G01N 21/47; G01N 21/88; G01N 21/95

(52) U.S. Cl. CPC G01N 21/956; G01N 21/47; G01N 21/8806; G01N 21/9501; G01N 2201/06113; G01N 2201/067

(57) ABSTRACT

capable of detecting a size of a large foreign matter with high accuracy is provided. A laser power monitor 109 measures, based on a monitor signal 132 from an optical sensor 107, laser power with which a surface of a sample 100 is irradiated. An optical sensor 111 receives light scattered or reflected from the surface of the sample 100, and outputs a sensor output signal 134 according to a received light amount. A controller determines presence or absence of a large foreign matter exceeding a predetermined size based on the sensor output signal 134, reduces the laser power using a variable optical attenuator 104 when it is determined that the large foreign matter is present, and corrects, based on a measurement value of the laser power by the laser power monitor 109, the sensor output signal 134 within a reduction period of the laser power.

### TECHNICAL FIELD

The present invention relates to an optical-type foreign matter inspection device.

### BACKGROUND ART

PTL 1 (WO2016/121756) discloses a technique for safely controlling laser power in an inspection device that controls laser power using an electro-optical element such as a Pockels cell. Specifically, the inspection device includes an electro-optical element that changes a phase of light from a light source to at least two states, and a control unit, and the control unit corrects a phase variation of the electro-optical element itself using an intensity modulation characteristic of the electro-optical element that is obtained by changing an applied voltage input to the electro-optical element.

### CITATION LIST

### Patent Literature

PTL 1: WO2016/121756

### SUMMARY OF INVENTION

### Technical Problem

The optical-type foreign matter inspection device irradiates a sample to be inspected with a laser beam using, for example, spiral scanning in which main scanning by rotational movement and sub-scanning by translational movement are combined, and detects, using an optical sensor, scattered light generated by irradiating a foreign matter or a defect on the sample or the like with the laser beam. At this time, when a large foreign matter is irradiated with the laser beam, a detected light amount may exceed a dynamic range of the optical sensor and reach a saturation level, or the foreign matter may be blasted and contaminate the sample. When the technique in PTL 1 is used, such a situation can be prevented by dynamically reducing the laser power in a peripheral region where the large foreign matter is present.

However, in a case where the laser power is reduced in the peripheral region of the large foreign matter, it may be necessary to switch the laser power in a short time and at a high speed in order to enable stable irradiation of the laser power to a region other than the peripheral region. There is a demand for an inspection device to have a wider dynamic range of a size of a detectable foreign matter. However, in the configuration disclosed in PTL 1, it is difficult to detect the size of the large foreign matter since the laser power is reduced.

The invention has been made in view of such circumstances, and an object of the invention is to provide an optical-type foreign matter inspection device capable of detecting a size of a large foreign matter with high accuracy.

The above and other objects and novel features of the invention will become apparent from the description of this specification and the accompanying drawings.

### Solution to Problem

An outline of a representative embodiment of the invention disclosed in the present application will be briefly described as follows.

An optical-type foreign matter inspection device according to one embodiment inspects a foreign matter on a surface of a sample, and includes a rotation stage, a laser light source, a variable optical attenuator, first and second optical sensors, a laser power monitor, and a controller. The rotation stage allows the sample to be placed thereon and rotates the sample. The laser light source irradiates the surface of the sample with a laser beam. The variable optical attenuator adjusts laser power of the laser beam with which the surface of the sample is irradiated by being inserted in an optical path of the laser beam. The first optical sensor receives the laser beam transmitted through the variable optical attenuator and outputs a first detection signal according to a received light amount. The laser power monitor measures, based on the first detection signal, the laser power applied to the surface of the sample. The second optical sensor receives light scattered or reflected from the surface of the sample and outputs a second detection signal according to a received light amount. The controller determines, based on the second detection signal, presence or absence of a large foreign matter exceeding a predetermined size, reduces the laser power using the variable optical attenuator when it is determined that the large foreign matter is present, and corrects, based on a measurement value of the laser power by the laser power monitor, the second detection signal within a reduction period of the laser power.

### ADVANTAGEOUS EFFECTS OF INVENTION

To briefly explain the effects obtained by typical embodiments of the invention disclosed in the present application, a size of a large foreign matter can be detected with high accuracy in an optical-type foreign matter inspection device that irradiates a sample with a laser beam.

### BRIEF DESCRIPTION OF DRAWINGS

FIG. 1A is a schematic diagram illustrating a configuration example of an optical-type foreign matter inspection device according to Embodiment 1.

FIG. 1B is a diagram illustrating an example of a representative implementation form of each unit illustrated in FIG. 1A.

FIG. 2 is a waveform diagram illustrating an operation example of each unit in FIG. 1A when a large Foreign Matter Is Present.

FIG. 3 is a waveform diagram illustrating an operation example of a laser light source and an optical sensor in FIG. 1A in an optical-type foreign matter inspection device according to Embodiment 2.

FIG. 4 is a circuit block diagram illustrating a configuration example of a laser power monitor in FIG. 1A in the optical-type foreign matter inspection device according to Embodiment 2.

FIG. 5 is a waveform diagram illustrating an operation example of the laser power monitor illustrated in FIG. 4.

FIG. 6 is a circuit block diagram illustrating a configuration example of the laser power monitor in FIG. 1A in an optical-type foreign matter inspection device according to Embodiment 3.

FIG. 7 is a circuit block diagram illustrating a configuration example of the laser power monitor in FIG. 1A in an optical-type foreign matter inspection device according to Embodiment 4.

FIG. 8 is a schematic diagram illustrating a configuration example of an optical-type foreign matter inspection device according to Embodiment 5.

FIG. 9 is a diagram illustrating an example of a state in which laser power according to inner and outer peripheries of a sample in FIG. 8 is controlled.

FIG. 10 is a schematic diagram illustrating a configuration example of a gain correction unit in FIG. 1A in an optical-type foreign matter inspection device according to Embodiment 6.

FIG. 11 is a diagram illustrating an operation example of the gain correction unit illustrated in FIG. 10.

FIG. 12 is a flow diagram illustrating an example of a calibration method when laser power fluctuates due to a change over time, an environmental change, or the like in an optical-type foreign matter inspection device according to Embodiment 7.

### DESCRIPTION OF EMBODIMENTS

Hereinafter, embodiments of the invention will be described in detail with reference to the drawings. In the drawings, the same components are denoted by the same reference numerals in principle, and repeated description thereof is omitted. When there are a plurality of identical or similar components, the same reference numerals may be assigned with different subscripts. In the drawings, expressions of each component may not represent an actual position, size, shape, range, and the like in order to facilitate understanding of the invention, and the invention is not necessarily limited to the position, size, shape, range, and the like disclosed in the drawings. Expressions such as identification information, an identifier, an ID, a name, and a number of various kinds of data and information can be mutually replaced.

For the sake of description, in the case of describing processing executed by a program, a program, a function, a processing unit, and the like may be described as a main body, but a main body of hardware thereof is a processor, or a controller, a device, a computer, a system or the like implemented with a processor. The computer executes processing according to a program read onto a memory by a processor while appropriately using resources such as a memory and a communication interface. Accordingly, a predetermined function, processing unit, and the like are implemented.

The processor is implemented with, for example a semiconductor device such as a CPU or a GPU. The processor is implemented by a device or a circuit capable of performing a predetermined calculation. Processing can be executed not only by software program processing but also by a dedicated circuit. The dedicated circuit may be a field programmable gate array (FPGA) or an application specific integrated circuit (ASIC), or the like. The program may be installed as data in a target computer in advance, or may be distributed as data from a program source to a target computer and installed. The program source may be a program distribution server on a communication network or a non-transitory computer-readable storage medium. The program may include a plurality of program modules. The computer system may include a plurality of devices.

### Embodiment 1

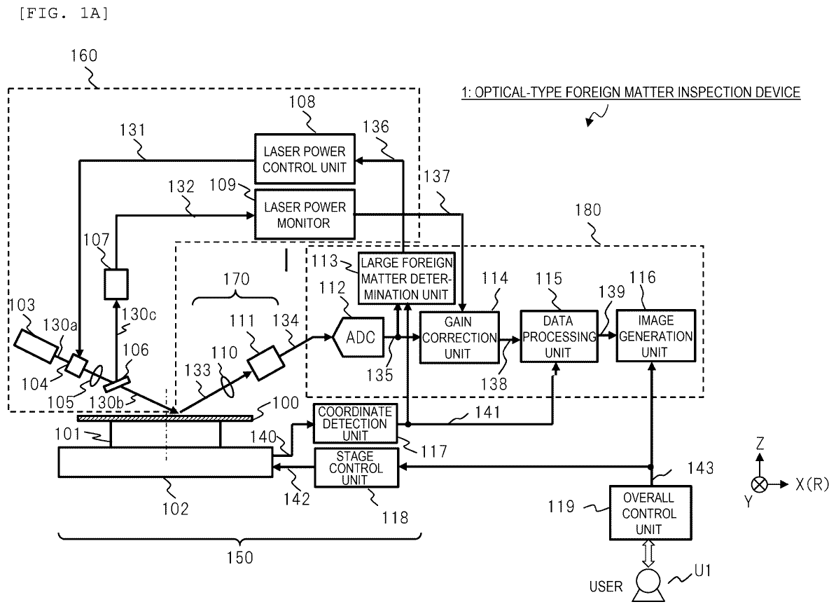

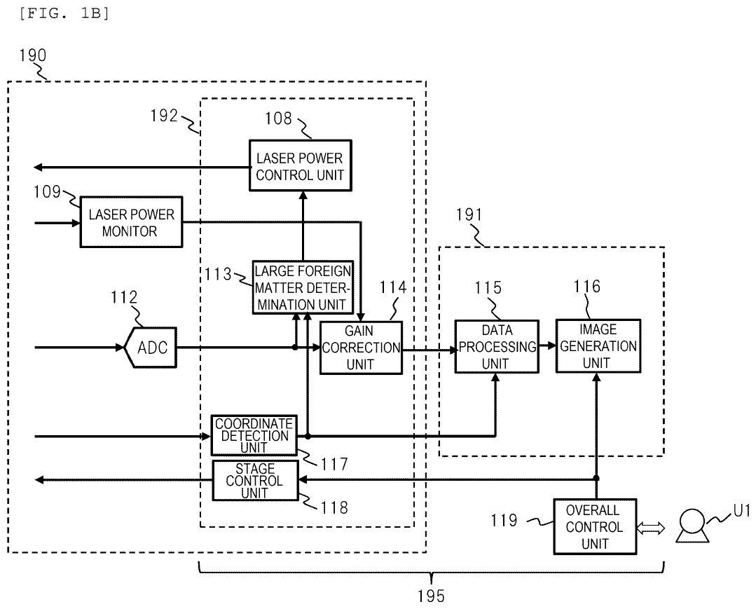

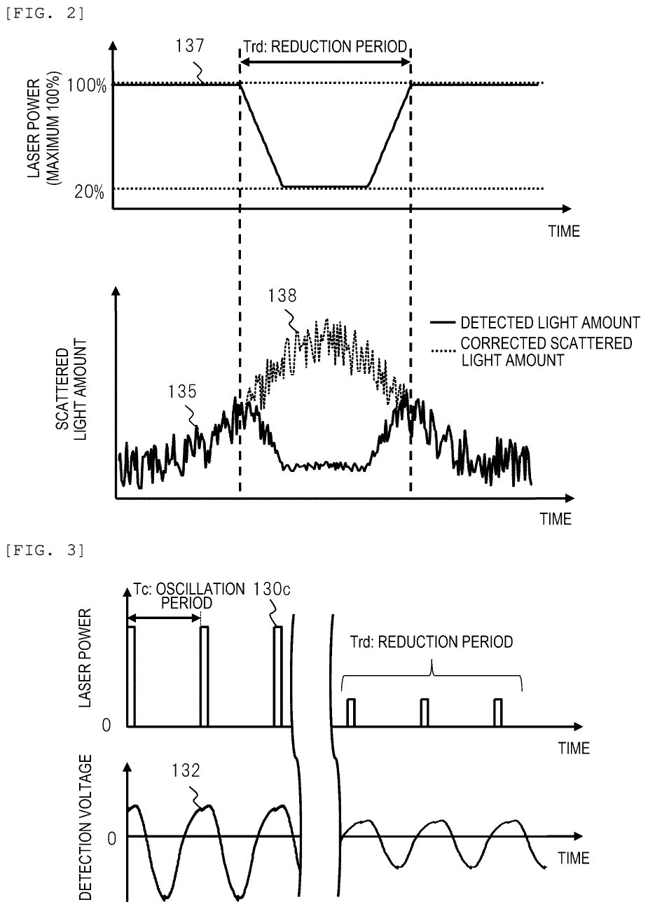

according to Embodiment 1 will be described with reference to FIGS. 1A, 1B, and 2. The optical-type foreign matter inspection device according to Embodiment 1 performs foreign matter inspection on a sample such as a semiconductor wafer. The optical-type foreign matter inspection device generally includes a stage moving unit that rotates and translates a sample, an irradiation unit that irradiates a surface of the sample with a laser beam, a unit that controls a variable optical attenuator to switch laser power to low power in a peripheral region of a large foreign matter, and a unit that measures the laser power by inputting a part of the irradiated laser beam to an optical sensor via a half mirror.

Further, the optical-type foreign matter inspection device includes a detection unit that detects scattered light or the like generated from the surface of the sample by irradiation with the irradiation unit and outputs a detection signal, a unit that corrects the detection signal based on the laser power, and an image generation unit that generates and outputs an image in which detected foreign matter information is mapped on the sample surface. Here, the optical-type foreign matter inspection device according to Embodiment 1 acquires the laser power even during a period when the laser power is reduced for a certain period of time due to detection of a large foreign matter, and corrects the detection signal of the scattered light or the like by multiplying the detection signal by a gain according to the laser power. Accordingly, even though the laser power is reduced, a size of even a large foreign matter can be detected with high accuracy.

### Outline of Optical-Type Foreign Matter Inspection Device

FIG. 1A is a schematic diagram illustrating a configuration example of the optical-type foreign matter inspection device according to Embodiment 1. The optical-type foreign matter inspection device 1 illustrated in FIG. 1 includes a stage 150, an irradiation optical system 160, a detection optical system 170, a processing system 180, and an overall control unit 119.

The stage 150 includes a rotation stage 101, a translation stage 102, a coordinate detection unit 117, and a stage control unit 118. The rotation stage 101 allows a sample 100 such as a semiconductor wafer to be placed on an upper surface thereof, and holds the placed sample 100. The rotation stage 101 rotates the sample 100 with an illustrated Z direction as a rotation axis as a reference. The translation stage 102 translates the rotation stage 101, on which the sample 100 is placed, within a horizontal plane (X-Y plane) with the rotation axis being a vertical direction. Specifically, the translation stage 102 translates the rotation stage 101 in a radial direction R of rotation by a combination of an X direction and a Y direction.

Based on an instruction from the overall control unit 119, the stage control unit 118 drives the rotation stage 101 and the translation stage 102 using a motor control signal, in other words, a stage drive signal 142, thereby controlling rotation of the rotation stage 101 and translation of the translation stage 102. The coordinate detection unit 117 receives encoder information 140 representing a rotation angle of the rotation stage 101 and a translational movement amount of the translation stage 102, and outputs coordinate information 141 by processing the encoder information 140. Coordinates on the sample 100 irradiated with the laser beam can be obtained from the coordinate information 141.

The irradiation optical system 160 includes a laser light source 103, a variable optical attenuator 104, a lens 105, a half mirror 106, an optical sensor (first optical sensor) 107, a laser power control unit 108, and a laser power monitor 109. The laser light source 103 irradiates a surface of the sample 100 with a laser beam 130a. The variable optical attenuator 104 is inserted into an optical path of the laser beam and adjusts laser power of a laser beam 130b with which the surface of the sample 100 is irradiated. Specifically, the variable optical attenuator 104 adjusts the laser power by controlling a transmittance based on transmittance control information 131 from the laser power control unit 108, in other words, a control amount, and irradiates the sample 100 with the transmitted laser beam 130b.

The lens 105 focuses and images the laser beam 130b transmitted through the variable optical attenuator 104 at a target portion of the sample 100. The half mirror 106 emits a laser beam 130c, which is a part of the laser beam 130b, to an optical sensor 107. The optical sensor (first optical sensor) 107 receives the laser beam 130b transmitted through the variable optical attenuator 104, more specifically, the laser beam 130c which is a part of the laser beam 130b, and outputs a monitor signal (first detection signal) 132 according to a received light amount.

The laser power monitor 109 measures, based on the monitor signal 132, the laser power with which the surface of the sample 100 is irradiated, and outputs a measurement value of the laser power as laser power information 137. Details of the laser power monitor 109 will be described in an embodiment to be described later. The variable optical attenuator 104 may have various types of configurations. In the embodiment, as an example of the variable optical attenuator 104, a configuration is used that includes an electro-optical element such as a Pockels cell capable of switching a laser polarization direction at a high speed by applying a voltage and a polarization beam splitter whose transmittance changes according to the polarization direction. By using such a configuration, responsiveness of the variable optical attenuator 104 can be improved.

The detection optical system 170 includes a lens 110 and an optical sensor (second optical sensor) 111. The lens 110 focuses and images scattered light 133 or reflected light generated from the surface of the sample 100 irradiated with the laser beam 130b. The optical sensor 111 receives the scattered light 133 or the reflected light focused and imaged by the lens 110, and outputs a sensor output signal (second detection signal) 134 according to a received light amount. The optical sensors 107 and 111 are, for example, a photodiode (PD) sensor, a CMOS sensor, or a CCD sensor.

The processing system 180 includes an A/D conversion circuit 112, a large foreign matter determination unit 113, a gain correction unit 114, a data processing unit 115, and an image generation unit 116. The A/D conversion circuit 112 samples the sensor output signal 134 and converts the sensor output signal 134 into a digital value, and outputs the digital value as an ADC output signal 135. When the optical sensor 111 is, for example, a CMOS sensor, the ADC output signal 135 represents digital pixel information corresponding to a two-dimensional array of elements, and represents a pixel value for each pixel, that is, a value such as a light intensity.

Details of the large foreign matter determination unit 113 and the gain correction unit 114 will be described later. Schematically, the large foreign matter determination unit 113 determines, based on the ADC output signal 135 and the sensor output signal 134 from the optical sensor 111, the presence or absence of a large foreign matter exceeding a predetermined size. The gain correction unit 114 performs gain correction on the ADC output signal 135 to output a correction output signal 138.

The data processing unit 115 receives the correction output signal 138 and the coordinate information 141 from the coordinate detection unit 117, performs detection and determination of a foreign matter, and outputs detection data 139 representing, for example, a size and coordinates of the detected foreign matter. In the detection and determination of the foreign matter in the processing system 180, for example, whether a foreign matter is present may be determined by a method such as comparison between a pixel value and a threshold value, and a detailed method is not limited.

The image generation unit 116 generates and outputs position coordinates of a foreign matter and the like on the sample 100 as an image (also referred to as mapping image) based on the detection data 139. The image from the image generation unit 116 can be displayed, for example, on a display screen of a display device built into or connected to the processing system 180. The coordinate information of the foreign matter may be acquired from the stage 150, the stage control unit 118, or the overall control unit 119.

The overall control unit 119 controls the entire optical-type foreign matter inspection device 1 based on an instruction from a user U1. As one example, the overall control unit 119 may output inspection information 143 including a rotation speed of the rotation stage 101, a translation speed of the translation stage 102, and the like to the stage control unit 118, and may additionally output the inspection information 143 to the image generation unit 116. The user U1 is an operator who operates and uses the optical-type foreign matter inspection device 1. The user U1 performs tasks related to foreign matter inspection by inputting an instruction and a setting, checking an image and information, and the like through an input device or an output device (including a display device) (not illustrated) that is connected to the overall control unit 119.

FIG. 1B is a diagram illustrating an example of a representative implementation form of each unit illustrated in FIG. 1A. The optical-type foreign matter inspection device 1 illustrated in FIG. 1A includes, for example, a dedicated circuit board 190 and a computer 191. The dedicated circuit board 190 includes a high-speed controller 192, the laser power monitor 109, and the A/D conversion circuit 112. The high-speed controller 192 includes the laser power control unit 108, the large foreign matter determination unit 113, the gain correction unit 114, the coordinate detection unit 117, and the stage control unit 118.

The high-speed controller 192 includes, for example, a general-purpose circuit such as a micro-controller including a processor and a memory, an FPGA, an ASIC, or a combination thereof. When implemented by a general-purpose circuit, each unit in the high-speed controller 192 can be implemented by a processor executing a program stored in the memory. Here, in particular, the large foreign matter determination unit 113, the gain correction unit 114, and the laser power control unit 108 may require a certain degree of processing speed in order to execute processing according to a large foreign matter, which will be described later. Therefore, in this example, the high-speed controller 192 is mounted on the dedicated circuit board 190.

The laser power monitor 109 can be implemented by, for example, a dedicated circuit. A detailed circuit configuration of the laser power monitor 109 will be described in an embodiment to be described later. The A/D conversion circuit 112 can be implemented by a dedicated circuit or may be mounted as a built-in circuit such as a micro-controller or an FPGA. The dedicated circuit board 190 communicates with the computer 191 via a communication interface (not illustrated).

The computer 191 includes the data processing unit 115 and the image generation unit 116. The computer 191 can be implemented by, for example, a server device including a processor, a memory, a communication interface, an input and output interface, a bus, and the like. In this case, the data processing unit 115 and the image generation unit 116 can be implemented by the processor executing a program stored in the memory.

The overall control unit 119 also can be implemented by a computer including a processor, a memory, a communication interface, an input and output interface, and a bus, such as a client terminal device. That is, the optical-type foreign matter inspection device 1 may be implemented by a client-server computer system. In this case, the user U1 can use various functions of the optical-type foreign matter inspection device 1 by accessing the computer 191, that is, a server device using the overall control unit 119, that is, a client terminal device.

As a specific example, the client terminal device of the user U1 may acquire screen data including a GUI by accessing the image generation unit 116 in the server device and display the screen data on the display screen of the client terminal device. The user U1 inputs information on an instruction or a setting to the screen including the GUI, and the client terminal device transmits the information to the server device. The server device controls an operation related to foreign matter inspection based on the information from the client terminal device, and transmits data of a screen including a mapping image of an inspection result and a GUI to the client terminal device. The client terminal device displays the screen, and the user U1 looks at the screen to check for a foreign matter, and the like.

Here, the high-speed controller 192, the computer 191, and the overall control unit 119 illustrated in FIG. 1B are basically parts responsible for digital signal processing. In the description, a part responsible for the digital signal processing is referred to as a controller 195. An implementation form of the controller 195 is not limited to the example illustrated in FIG. 1B, and can be changed as appropriate. That is, the controller 195 may be implemented by any one of a processor, an FPGA, an ASIC, and the like, or a combination thereof, and the number of components required for implementation can also be determined in various ways.

### Details of Large Foreign Matter Determination Unit, Laser Power Control Unit, and Gain Correction Unit

Specifically, the large foreign matter determination unit 113 illustrated in FIG. 1A determines that one with a large scattered light amount is a large foreign matter based on the ADC output signal 125, and further determines coordinates where the large foreign matter is present based on the coordinate information 141. A specific method of determining the large foreign matter may be various methods, and is not particularly limited. Typically, for example, when the scattered light amount at a certain rotation angle exceeds a certain threshold, it is determined that there is a large foreign matter.

Here, it is known that the scattered light amount according to irradiation with the laser beam becomes Rayleigh scattering when the size of the foreign matter is sufficiently small compared to a light wavelength, and it is known that the scattered light amount is proportional to the sixth power of a diameter of the foreign matter. Further, the scattered light amount is proportional to an incident light amount, that is, the laser power. Therefore, when the laser power is constant, whether there is a large foreign matter can be determined based on a magnitude of the scattered light amount.

On the other hand, when the laser power is constant, the scattered light amount from a large foreign matter is very large, so that the sensor output signal 134 from the optical sensor 111 may be saturated. That is, the optical sensor 111 generally has a dynamic range capable of detecting a small foreign matter with high accuracy, but a large foreign matter may be outside the dynamic range. Further, in a case where the laser power is constant, when the laser power is applied to the large foreign matter, contamination of the sample 100 may occur due to explosion of the foreign matter.

Therefore, when the laser beam reaches the coordinates where the large foreign matter is present, the large foreign matter determination unit 113 outputs, to the laser power control unit 108, power control information 136 representing that the laser power is to be reduced. For example, during a spiral scanning process, by significantly reducing the laser power using the variable optical attenuator 104 during a certain period when passing through a rotation angle at which the large foreign matter is determined present, saturation of the sensor output signal 134 from the optical sensor 111 and contamination of the sample 100 due to explosion of the foreign matter can be avoided.

As described above, however, the scattered light amount is proportional to the laser power. Therefore, when the laser power is reduced due to the large foreign matter, a range of the scattered light amount also changes, and it may be difficult to detect the size of the large foreign matter with high accuracy only with the sensor output signal 134. On the other hand, when the reduced laser power can be measured at a high speed and with high accuracy, the size of the large foreign matter can be detected with high accuracy by correcting the sensor output signal 134 based on the measurement value of the laser power. The gain correction unit 114 performs such correction.

It is desirable that a length of a reduction period of the laser power due to the large foreign matter is short, including a power switching time, so as not to affect foreign matter detection in a region other than the large foreign matter. In addition to the viewpoint of the gain correction described above, also from this viewpoint, it is desirable that the laser power monitor 109 outputs the laser power information 137 following a change in laser power at a high speed on the order of nanoseconds, for example. In Embodiment 1, it is assumed that the sufficiently high-speed laser power monitor 109 as illustrated in an embodiment to be described later is used.

FIG. 2 is a waveform diagram illustrating an operation example of each unit in FIG. 1A when a large foreign matter is present. FIG. 2 illustrates the laser power information 137 from the laser power monitor 109 that represents the measurement value of the laser power, the ADC output signal 135 representing the scattered light amount, and the sensor output signal (second detection signal) 134 from the optical sensor 111. When the large foreign matter determination unit 113 determines that there is a large foreign matter, the laser power is reduced via the laser power control unit 108 and the variable optical attenuator 104.

As a result, the laser power information 137 including a reduction period Trd of the laser power as illustrated in FIG. 2 is output from the laser power monitor 109. The laser power in the reduction period Trd is 20% in this example, with normal laser power being 100%. A length of the reduction period Trd is, for example, about 50 μs, and is fixedly determined in advance. The scattered light amount during the reduction period Trd, that is, the ADC output signal 135 can be reduced according to a reduction rate of the laser power, as indicated by a solid line in FIG. 2. Therefore, it may be difficult to detect the size of the large foreign matter only with the ADC output signal 135.

Therefore, during the reduction period Trd, the gain correction unit 114 corrects the ADC output signal 135 by multiplying the ADC output signal 135, and therefore the sensor output signal (second detection signal), by a reciprocal of the measurement value of the laser power represented by the laser power information 137. Accordingly, the gain correction unit 114 can generate and output the correction output signal 138 that is close to a true scattered light amount, as indicated by a dotted line in FIG. 2. As described above, as a result of obtaining the correction output signal 138 that is close to the true scattered light amount even during the reduction period Trd, the size of the large foreign matter can be detected with high accuracy based on the correction output signal 138.

A start point of the reduction period Trd in FIG. 2 may be determined in consideration of a control delay. For example, based on a change in scattered light amount during the process of performing spiral scanning, a rotation position and a rotation angle at which substantial irradiation of the large foreign matter is started can be predicted at an earlier rotational position, and the start point can be determined based on this prediction. The reduction period Trd may occur, for example, a predetermined number of times for one large foreign matter at intervals required for one rotation of the rotation stage.

The gain correction unit 114 may operate at all times regardless of whether the time is in the reduction period Trd. That is, the laser power information 137 in a normal state is 100%. Therefore, in the normal state, the gain correction unit 114 multiplies the ADC output signal 135 by 1, and substantially does not perform gain correction.

### Main Effects of Embodiment 1

As described above, in the method of Embodiment 1, the gain correction unit 114 is provided that corrects, based on the measurement value of the reduced laser power, the scattered light amount detected during the period when the laser power is reduced due to the large foreign matter. Accordingly, the size of the large foreign matter can be detected with high accuracy. Further, since the dynamic range of the size of the detectable foreign matter can be expanded, the performance of the optical-type foreign matter inspection device 1 can be improved.

### Embodiment 2

### Laser Light Source and Optical Sensor

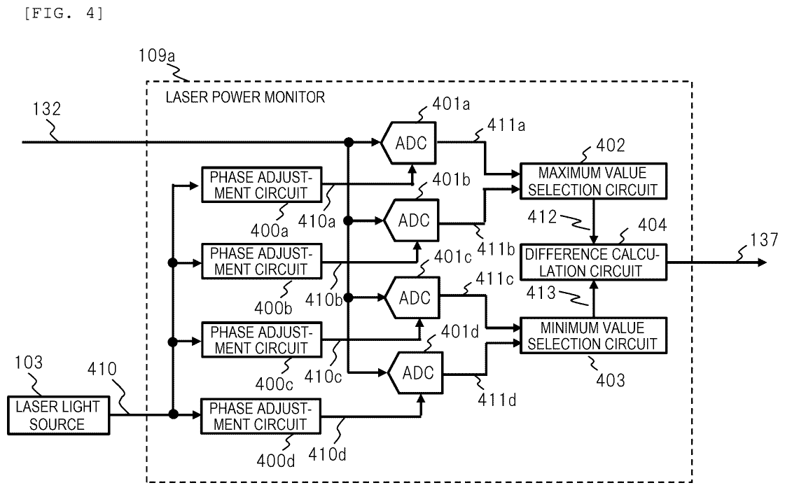

FIG. 3 is a waveform diagram illustrating an operation example of the laser light source 103 and the optical sensor 107 in FIG. 1A in an optical-type foreign matter inspection device according to Embodiment 2. As illustrated in FIG. 3, here, the laser light source 103 has a pulsed laser type configuration that outputs a pulse in synchronization with a laser oscillation clock of an oscillation period Tc. In order to detect a smaller foreign matter, a laser having a short wavelength and a high output may be required. From this viewpoint, it is suitable to use a pulsed laser type as the laser light source 103. When a pulsed laser type is used, unlike when a continuous wave type is used, it is necessary to devise to measure laser power.

In FIG. 3, the monitor signal (first detection signal) 132 from the optical sensor (first optical sensor) 107 according to the laser beam 130c from the laser light source 103 is illustrated. In this example, an AC coupling type is used as the optical sensor 107, but a DC coupling type may be used. In a case of the AC coupling type, when the laser beam 130c changes, a direct-current component is cut, which causes a positive voltage and a negative voltage to change, and as a result, an amplitude of the monitor signal 132 changes. That is, in order to measure the laser power with high accuracy, it is necessary to measure both the positive voltage and the negative voltage and calculate the amplitude.

### Details of Laser Power Monitor

FIG. 4 is a circuit block diagram illustrating a configuration example of the laser power monitor 109 in FIG. 1A in the optical-type foreign matter inspection device according to Embodiment 2. Since in the optical-type foreign matter inspection device, it is generally required to obtain a steady value of the laser power, for example, a method of detecting an average value of laser power using a low-pass filter or the like is used. In such a method, it may be difficult to perform gain correction as illustrated in FIG. 2 and the like. Therefore, it is beneficial to use a configuration example as illustrated in FIG. 4.

A laser power monitor 109a illustrated in FIG. 4 includes a plurality of phase adjustment circuits 400a to 400d, a plurality of A/D conversion circuits 401a to 401d, a maximum value selection circuit 402, a minimum value selection circuit 403, and a difference calculation circuit 404. The monitor signal (first detection signal) 132 from the optical sensor 107 is input to the plurality of (four in this example) A/D conversion circuits 401a to 401d via an analog circuit such as an amplifier or a filter (not illustrated).

The plurality of A/D conversion circuits 401a to 401d sample the monitor signal 132 according to sampling clocks 410a to 410d, and convert the monitor signal 132 into digital data 411a to 411d, respectively. In this example, the upper two A/D conversion circuits 401a and 401b are for peak detection, which detect peak values according to the sampling clocks 410a and 410b each having a phase near a peak value of the monitor signal 132. The lower two A/D conversion circuits 401c and 401d are for bottom detection, which detect bottom values according to the sampling clocks 410c and 410d each having a phase near a bottom value of the monitor signal 132.

The phase adjustment circuits 400a to 400d generate a plurality of sampling clocks 410a to 410d having different phases by adjusting a phase of a laser oscillation clock 410 received from the laser light source 103, and output each of the plurality of sampling clocks 410a to 410d to a respective one of the plurality of A/D conversion circuits 401a to 401d. As described above, by generating the sampling clocks 410a to 410d synchronized with the laser oscillation clock 410, the plurality of A/D conversion circuits 401a to 401d can detect the peak value and the bottom value with high accuracy.

The maximum value selection circuit 402 selects a maximum value from the digital data 411a and 411b representing peak values detected by the peak detection A/D conversion circuits 401a and 401b. The minimum value selection circuit 403 selects a minimum value from the digital data 411c and 411d representing bottom values detected by the bottom detection A/D conversion circuits 401c and 401d. The difference calculation circuit 404 calculates, as laser power information 137, that is, a measurement value of the laser power, a difference value between a maximum value 412 selected by the maximum value selection circuit 402 and a minimum value 413 selected by the minimum value selection circuit 403.

Here, a relationship between the difference value from the difference calculation circuit 404 and the laser power information 137, that is, a gain of the difference calculation circuit 404 and therefore the laser power monitor 109a is determined in advance based on output information of the laser light source 103 and calibrated laser power obtained from the laser power monitor 109a. The gain of the laser power monitor 109a is determined not only by the gain of the difference calculation circuit 404, that is, a gain for the laser power information 137, but also by gains of the A/D conversion circuits 401a to 401d and a gain of a variable amplifier inserted in a path of the monitor signal 132.

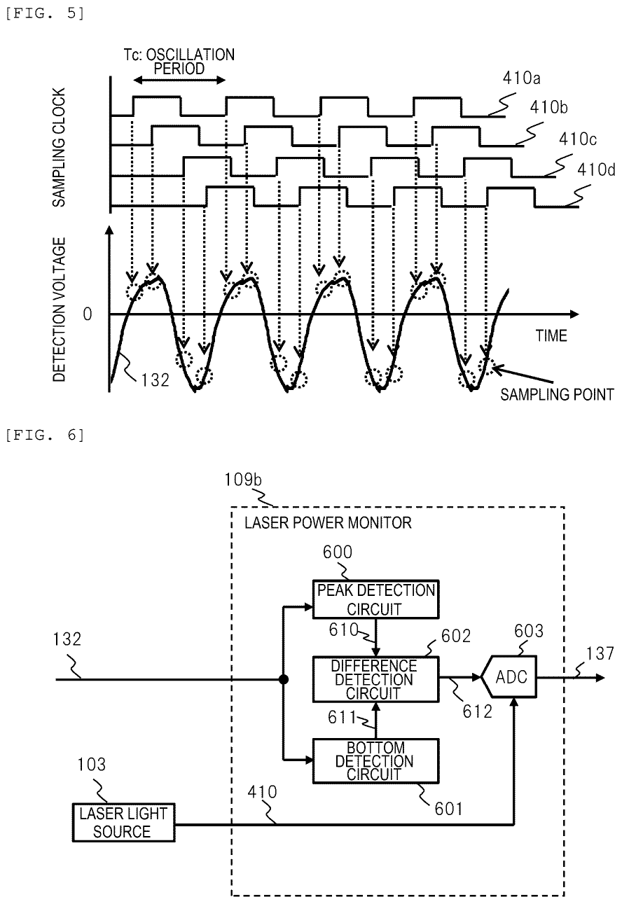

FIG. 5 is a waveform diagram illustrating an operation example of the laser power monitor 109a illustrated in FIG. 4. As illustrated in FIG. 5, the phase adjustment circuits 400a and 400b adjust the sampling clocks 410a and 410b to have different phases near the peak value of the monitor signal 132. The phase adjustment circuits 400c and 400d adjust the sampling clocks 410c and 410d to have different phases near the bottom value of the monitor signal 132. The phase adjustment circuits 400a to 400d may each include a variable delay circuit such as a multi-stage inverter circuit.

Here, two peak detection A/D conversion circuits are provided, but three or more may be provided, or in some cases only one may be provided. When one peak detection A/D conversion circuit is provided, the maximum value selection circuit 402 is unnecessary. From the viewpoint of detecting the peak value with high accuracy, it is desirable to provide two or more peak detection A/D conversion circuits. In this case, even when there is a deviation in sampling point due to jitter in the sampling clock or the like, the peak value and the bottom value can be detected with a relatively high degree of accuracy. The same applies to the bottom detection A/D conversion circuit.

### Main Effects of Embodiment 2

As described above, by using the method according to Embodiment 2, the effects same as those described in Embodiment 1 can be obtained. Further, by detecting the amplitude of the monitor signal 132 using the laser oscillation clock 410 from the laser light source 103, the measurement value of the laser power can be obtained with high accuracy. As a result, the gain correction illustrated in FIG. 2 and the like can be performed with high accuracy.

### Embodiment 3

### Details of Laser Power Monitor

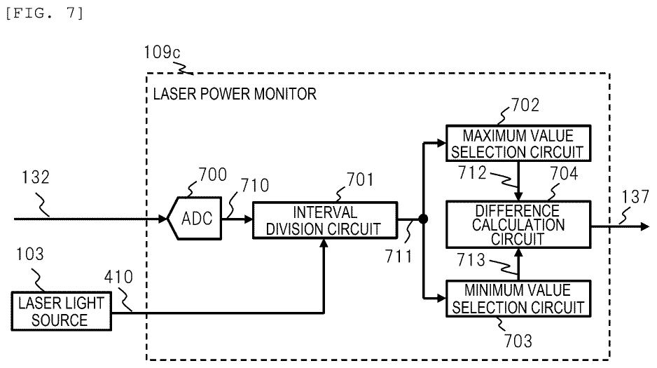

FIG. 6 is a circuit block diagram illustrating a configuration example of the laser power monitor 109 in FIG. 1A in an optical-type foreign matter inspection device according to Embodiment 3. Here, as in the case of FIG. 4, it is assumed that the laser light source 103 has a pulsed laser type configuration. A laser power monitor 109b illustrated in FIG. 6 includes a peak detection circuit 600, a bottom detection circuit 601, a difference detection circuit 602, and an A/D conversion circuit 603. In FIG. 6, the monitor signal (first detection signal) 132 from the optical sensor 107 is input to the peak detection circuit 600 and the bottom detection circuit 601 via an analog circuit such as an amplifier or a filter (not illustrated).

The peak detection circuit 600 detects a peak voltage of the monitor signal 132. The bottom detection circuit 601 detects a bottom voltage of the monitor signal 132. The peak detection circuit 600 includes, for example, an envelope detection circuit including a forward diode, a capacitor that holds an output voltage of the forward diode, and a switch that initializes a voltage of the capacitor. The peak detection circuit 600 detects a positive-side envelope. The bottom detection circuit 601 includes, for example, an envelope detection circuit including a reverse diode, a capacitor that holds an output voltage of the reverse diode, and a switch that initializes a voltage of the capacitor. The bottom detection circuit 601 detects a negative-side envelope.

The difference detection circuit 602 detects a difference voltage 612 between a peak voltage 610 detected by the peak detection circuit 600 and a bottom voltage 611 detected by the bottom detection circuit 601. The A/D conversion circuit 603 samples the difference voltage 612 from the difference detection circuit 602 according to the laser oscillation clock 410 from the laser light source 103, converts the difference voltage 612 into digital data, and outputs the digital data as the laser power information 137, that is, a measurement value of laser power.

With such a configuration, the laser power information 137 is obtained for each oscillation period of the laser oscillation clock 410. A gain of the laser power monitor 109b is determined by a gain of the difference detection circuit 602, a gain of the A/D conversion circuit 603, a gain of a variable amplifier inserted in a path of the monitor signal 132, and the like.

### Main Effects of Embodiment 3

As described above, by using the method according to Embodiment 2, the effects same as those described in Embodiment 1 can be obtained. Further, by using the envelope detection circuit, the measurement value of the laser power can be obtained with high accuracy. As a result, the gain correction illustrated in FIG. 2 and the like can be performed with high accuracy. Since peak and bottom detection is performed mainly using an analog circuit, the laser power monitor 109b can be implemented at low cost.

### Embodiment 4

### Details of Laser Power Monitor

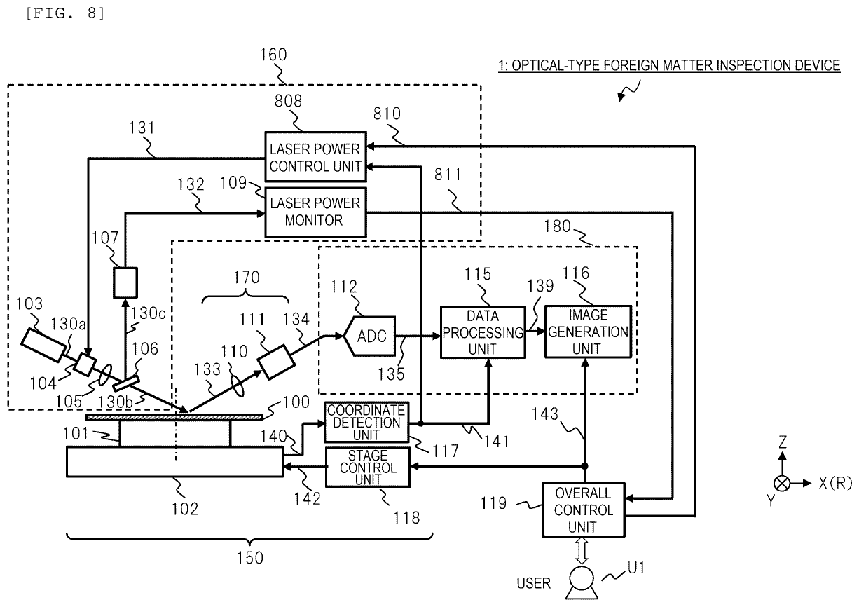

FIG. 7 is a circuit block diagram illustrating a configuration example of the laser power monitor 109 in FIG. 1A in an optical-type foreign matter inspection device according to Embodiment 4. Here, as in the case of FIG. 4, it is assumed that the laser light source 103 has a pulsed laser type configuration. A laser power monitor 109c illustrated in FIG. 7 includes an A/D conversion circuit 700, an interval division circuit 701, a maximum value selection circuit 702, a minimum value selection circuit 703, and a difference calculation circuit 704. In FIG. 7, the monitor signal (first detection signal) 132 from the optical sensor 107 is input to the A/D conversion circuit 700 via an analog circuit such as an amplifier or a filter (not illustrated).

The A/D conversion circuit 700 can operate with a sampling clock having a frequency twice or more, preferably 10 times or more higher than that of the laser oscillation clock 410 from the laser light source 103. For example, when the laser oscillation clock 410 is 100 MHz, the sampling clock is 1 GHz or the like. As the A/D conversion circuit 700 that operates at such a speed, for example, a flash type or a pipeline type is known.

The A/D conversion circuit 700 samples the monitor signal 132 with a high-speed sampling clock and converts the monitor signal 132 into digital data 710. The interval division circuit 701 divides the digital data 710 from the A/D conversion circuit 700 for each data group for one period based on the laser oscillation clock 410. That is, the interval division circuit 701 divides the sequentially received digital data 710 such that a peak and a bottom are detected for each oscillation period of the laser oscillation clock 410.

The maximum value selection circuit 702 selects a maximum value from the data group for one period from the interval division circuit 701. The minimum value selection circuit 703 selects a minimum value from the data group for one period from the interval division circuit 701. For example, when a sampling period of the A/D conversion circuit 700 is 1/10 of an oscillation period of the laser light source 103, the maximum value selection circuit 702 and the minimum value selection circuit 703 respectively select a maximum value and a minimum value from 10 points of the digital data 711 from the interval division circuit 701 for each oscillation period. The difference calculation circuit 704 calculates, as the laser power information 137, that is, a measurement value of laser power, a difference value between the maximum value 712 from the maximum value selection circuit 702 and the minimum value 713 from the minimum value selection circuit 703.

By providing such an interval division circuit 701, a peak and a bottom can be detected with high accuracy for each oscillation period of the laser oscillation clock 410, and processing is easier than interval detection based on zero crossing detection or the like. By increasing the number of digital data 711 from the interval division circuit 701 for each oscillation period, the peak and the bottom can be detected with higher accuracy.

Further, the peak and the bottom can be detected with higher accuracy by performing interpolation processing or the like on the interval-divided digital data 711. A gain of the laser power monitor 109c is determined by a gain of the difference calculation circuit 704, a gain of the A/D conversion circuit 700, a gain of a variable amplifier inserted in a path of the monitor signal 132, and the like.

### Main Effects of Embodiment 4

As described above, by using the method according to Embodiment 4, the effects same as those described in Embodiment 1 can be obtained. Further, by using the high-speed A/D conversion circuit 700, the measurement value of the laser power can be obtained with high accuracy. As a result, the gain correction illustrated in FIG. 2 and the like can be performed with high accuracy.

### Embodiment 5

### Outline of Optical-type Foreign Matter Inspection Device

FIG. 8 is a schematic diagram illustrating a configuration example of an optical-type foreign matter inspection device according to Embodiment 5. First, as a premise, in the optical-type foreign matter inspection device 1, when a rotation speed of the sample 100 is constant, a laser power density increases as an irradiation position of the laser beam 130b on the sample 100 is closer to an inner peripheral side, that is, a center side of the sample 100. Therefore, the closer the irradiation position is to the inner peripheral side of the sample 100, the more likely damage to the sample 100 becomes a problem.

Therefore, control is performed such that the laser power on the inner peripheral side of the sample 100 is reduced and the laser power is gradually increased toward an outer peripheral side. In this case, unlike a configuration including an electro-optical element and a polarization beam splitter described in Embodiment 1, the variable optical attenuator 104 generally includes a half-wave plate and a polarization beam splitter. In Embodiment 5, the variable optical attenuator 104 has the latter configuration.

The latter configuration has responsiveness lower than that of the former configuration, but has sufficient responsiveness from the viewpoint of controlling the laser power according to inner and outer peripheries of the sample 100. When the latter configuration is used, a laser power control unit 808 controls a rotation angle of the half-wave plate to change a laser polarization direction, and changes transmittance of the polarization beam splitter to control the laser power to be applied.

The optical-type foreign matter inspection device 1 illustrated in FIG. 8 is different from the configuration example illustrated in FIG. 1A in the following points. A first difference is that the laser power control unit 808 different from that in FIG. 1A is provided in the irradiation optical system 160. The laser power control unit 808 receives the coordinate information 141 from the coordinate detection unit 117 and laser power control information 810 from the overall control unit 119.

A second difference is that in the irradiation optical system 160, the laser power monitor 109 outputs laser power information 811 to the overall control unit 119. A third difference is that the large foreign matter determination unit 113 and the gain correction unit 114 are removed from the processing system 180. Therefore, the data processing unit 115 receives the ADC output signal 135 from the A/D conversion circuit 112.

### Controlling Method of Laser Power According to Inner and Outer Peripheries of Sample

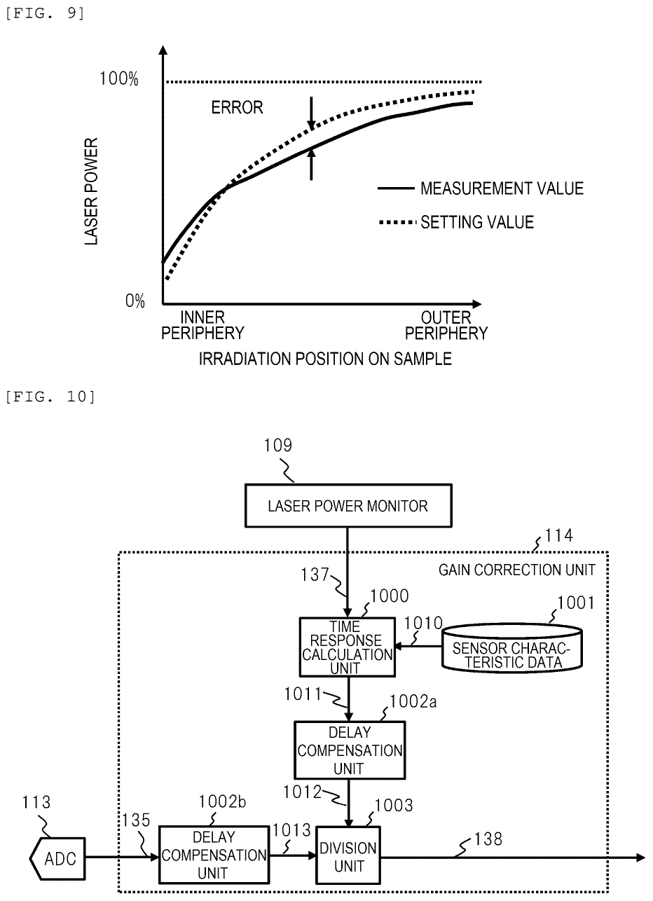

FIG. 9 is a diagram illustrating an example of a state in which laser power according to inner and outer peripheries of a sample in FIG. 8 is controlled. As illustrated in FIG. 9, the laser power is controlled to increase toward the outer periphery of the sample 100. At this time, first, the overall control unit 119 stores, as control information, a setting value of the laser power for each irradiation position on the sample 100, that is, for each coordinate within a horizontal plane (X-Y plane) in the translation stage 102, as indicated by a dotted line in FIG. 9, in a memory.

Further, the overall control unit 119 also stores, as the control information, the transmittance control information 131 for each coordinate within the horizontal plane, that is, a control amount of the variable optical attenuator 104. Then, the overall control unit 119 outputs, as the laser power control information 810, the transmittance control information 131 for each coordinate within the horizontal plane to the laser power control unit 808, and stores the information in a memory of the laser power control unit 808. The control information is stored in the memory as a table or a calculation formula, for example.

Accordingly, the laser power control unit 808 can receive the coordinate information 141 from the coordinate detection unit 117, and control, based on the control information stored in the memory, the laser power for each coordinate within the horizontal plane using the corresponding transmittance control information 131. However, as indicated by a solid line in FIG. 9, actual laser power has an error with respect to the setting value indicated by a dotted line due to, for example, a variation in transmittance of an optical element including the lens 105 and the like, a control delay of the variable optical attenuator 104, and the like. The error affects detection accuracy of a size of a foreign matter.

Therefore, the overall control unit 119 receives the laser power information 811 from the laser power monitor 109, that is, the measurement value of the laser power, for each coordinate within the horizontal plane, and calculates an error between the measurement value of the laser power and the setting value of the laser power stored in advance as the control information. That is, the overall control unit 119 calculates an error between the solid line and the dotted line for each irradiation position on the sample 100 in FIG. 9.

Then, based on the calculated error, the overall control unit 119 corrects the transmittance control information 131 included in the control information, that is, the control amount of the variable optical attenuator 104 such that the error approaches zero. The overall control unit 119 outputs the corrected transmittance control information 131 to the laser power control unit 808 as the laser power control information 810, and corrects the transmittance control information 131 stored in the memory of the laser power control unit 808. Accordingly, the control of the laser power as indicated by the dotted line in FIG. 9 can be actually implemented.

For this purpose, even when the laser power continuously changes as illustrated in FIG. 9 as a result of spiral scanning, a mechanism capable of measuring the laser power at a high speed and with high accuracy is required. Therefore, it is beneficial to use the laser power monitors 109a to 109c as described in Embodiments 2 to 4. The correction as illustrated in FIG. 9 is performed, for example, at the time of initial start-up of a device for the purpose of reducing a difference between devices. The correction as illustrated in FIG. 9 may be performed periodically or at a predetermined calibration timing for the purpose of reducing an error due to an environmental change or a change over time for each device.

### Modification

A configuration example illustrated in FIG. 8 can be combined with a configuration example illustrated in FIG. 1A. In this case, the laser power control unit 808 illustrated in FIG. 8 may be added to the configuration example illustrated in FIG. 1A, and the overall control unit 119 may be provided with functions as described with reference to FIG. 9. Further, in this case, it is desirable that the variable optical attenuator 104 is implemented in a plurality of stages by combining, for example, an attenuator having high responsiveness described in FIG. 1A and an attenuator having low responsiveness described in FIG. 8.

The laser power control unit 108 illustrated in FIG. 1A may control the attenuator having high responsiveness, and the laser power control unit 808 illustrated in FIG. 8 may control the attenuator having low responsiveness. By implementing the variable optical attenuator 104 with a plurality of stages of attenuators as described above, the plurality of stages of attenuators can be controlled independently of each other, and thus control of the laser power can be facilitated as compared with a case where the variable optical attenuator 104 is implemented with a single stage of attenuator.

### Main Effects of Embodiment 5

As described above, in the method of Embodiment 5, by correcting the control amount of the variable optical attenuator 104 using the laser power monitor 109 capable of measuring the laser power at a high speed and with high accuracy, the laser power according to the inner and outer peripheries of the sample can be controlled with high accuracy. As a result, the detection accuracy of the size of the foreign matter can be improved.

### Embodiment 6

### Details of Gain Correction Unit

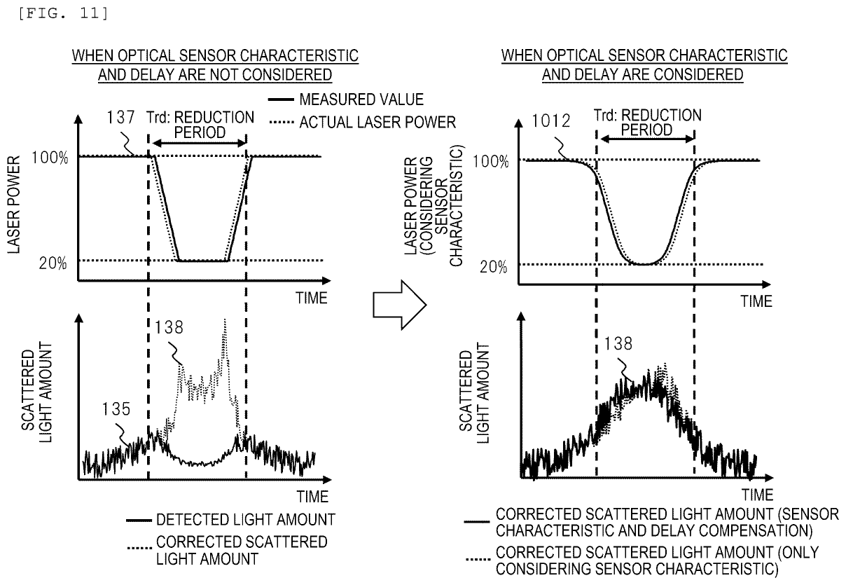

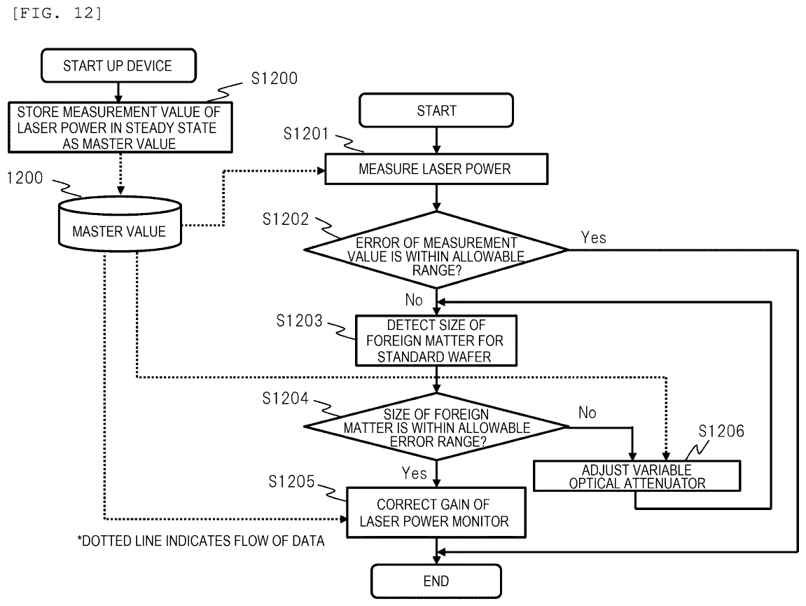

FIG. 10 is a schematic diagram illustrating a configuration example of a gain correction unit in FIG. 1A in an optical-type foreign matter inspection device according to Embodiment 6. FIG. 11 is a diagram illustrating an operation example of the gain correction unit illustrated in FIG. 10. First, as a premise, the optical sensor (second optical sensor) 111 that detects scattered light often has sufficiently low responsiveness compared to the optical sensor (first optical sensor) 107 that detects a laser beam.

In this case, as the responsiveness of the optical sensor 111 becomes lower than that of the optical sensor 107, a waveform of the ADC output signal 135 becomes dull compared to a waveform of the laser power information 137. Further, a delay amount of the ADC output signal 135 becomes larger than a delay amount of the laser power information 137. As a result, as illustrated on the left side in FIG. 11, when the ADC output signal 135 is directly multiplied by a reciprocal of the laser power information 137 during a reduction period Trd, a waveform of the correction output signal 138 greatly deviates from the Gaussian waveform that is a true waveform. In particular, when a gain becomes excessive before and after the laser power starts to increase, a foreign matter is detected as being larger in size than it actually is.

Therefore, the gain correction unit 114 illustrated in FIG. 10 includes a time response calculation unit 1000, delay compensation units 1002a and 1002b, a division unit 1003, and a memory 1001 in which sensor characteristic data 1010 is stored. The laser power information 137 from the laser power monitor 109 and the sensor characteristic data 1010 are input to the time response calculation unit 1000. The sensor characteristic data 1010 represents a previously known time response characteristic of the optical sensor (second optical sensor) 111, and is, for example, data such as a transfer function from optical input to voltage output that is obtained from a data sheet or an actual measurement value.

The time response calculation unit 1000 reflects the time response characteristic of the optical sensor 111 based on the sensor characteristic data 1010 in the laser power information 137, that is, a measurement value of laser power, thereby calculating the reflected laser power information 1011, that is, the reflected measurement value. The delay compensation units 1002a and 1002b receive the reflected laser power information 1011 and the ADC output signal 135, respectively, and compensate for a relative delay therebetween. Delay amounts of the delay compensation units 1002a and 1002b are determined in advance, for example, by performing a fitting operation using a standard wafer or the like in which a size of a foreign matter or the like is known. Here, two delay compensation units 1002a and 1002b are provided, but a configuration in which only one of them is provided may also be used.

The division unit 1003 corrects the original ADC output signal 135 by multiplying the delay-compensated ADC output signal 1013 by a reciprocal of the delay-compensated laser power information 1012 after the time response characteristic is reflected, and outputs the correction output signal 138. Accordingly, as illustrated on the right side of FIG. 11, the laser power information 1012 having a waveform shape matching an original waveform shape of the ADC output signal 135 and subjected to delay compensation can be generated. Then, by performing gain correction based on the laser power information 1012, the correction output signal 138 close to a true waveform can be generated.

### Main Effects of Embodiment 6

As described above, by using the method according to Embodiment 6, the effects same as those described in Embodiment 1 can be obtained. Further, by performing shaping of waveform shape and delay compensation on the measurement value of the laser power, gain correction during the reduction period of the laser power can be performed with higher accuracy.

### Embodiment 7

### Calibration Method of Laser Power

FIG. 12 is a flow diagram illustrating an example of a calibration method in a case where laser power fluctuates due to a change over time, an environmental change, or the like in an optical-type foreign matter inspection device according to Embodiment 7. An optical-type foreign matter inspection device according to Embodiment 7 has a configuration illustrated in FIG. 1A, a configuration illustrated in FIG. 8, or a combination thereof.

In FIG. 12, first, at the time of initial start-up of the optical-type foreign matter inspection device 1, a reference value to be used for calibrating the device is created. Specifically, for example, the overall control unit 119 operates the optical-type foreign matter inspection device 1 under a predetermined condition, and stores, as a master value 1200, the laser power information 137 and 811 measured using the laser power monitor 109 in a steady state, that is, a measurement value of laser power, in a memory (step S1200).

More specifically, at the time of initial start-up or the like, the sample 100 such as a standard wafer containing a foreign matter having a known size is to be inspected, and each unit of the optical-type foreign matter inspection device 1 is adjusted such that the entire device operates as desired, including ensuring that a size of the foreign matter that results from the inspection is within an acceptable error range. The master value 1200 is acquired after such adjustment is completed, and is treated as correct data. The master value 1200 is created for each device, taking into account an error component of each unit including the laser power monitor 109, and therefore may be a different value for each device.

After step S1200, the user U1 instructs start of calibration at any timing. Accordingly, for example, the overall control unit 119 measures the laser power using the laser power monitor 109 at any calibration timing under a predetermined condition same as that in step S1200, and acquires the laser power information 137 and 811, that is, the measurement value of the laser power (step S1201).

Then, the overall control unit 119 compares the acquired measurement value of the laser power with the master value 1200, and corrects a gain of the laser power monitor 109 or a control amount of the variable optical attenuator 104 when an error between the measurement value of the laser power and the master value 1200 is out of an allowable range. Specifically, the overall control unit 119 determines whether the error between the measurement value of the laser power and the master value 1200 is within the allowable range (step S1202). When the error is within the allowable range (step S1202: Yes), the calibration is unnecessary, and thus the overall control unit 119 ends the processing.

On the other hand, when the error is out of the allowable range (step S1202: No), the overall control unit 119 causes the optical-type foreign matter inspection device 1 to detect the size of the foreign matter on the standard wafer in order to determine whether the error increase is caused by a laser beam irradiation system or a monitor system (step S1203). Then, the overall control unit 119 determines whether the size of the detected foreign matter is within an allowable error range (step S1204).

Here, when the size of the foreign matter is within the allowable error range (step S1204: Yes), it is estimated that the error is increased due to the laser beam monitoring system. Therefore, the overall control unit 119 adjusts the gain of the laser power monitor 109 such that the laser power information 137 and 811, that is, the measurement value of the laser power matches the master value 1200 (step S1205). As described in Embodiments 2 to 4, the gain of the laser power monitor 109 is adjusted by a gain for the monitor signal 132, a gain for the laser power information 137, and the like.

On the other hand, when the size of the foreign matter is out of the allowable error range (step S1204: No), it is estimated that the error is increased due to the laser beam irradiation system. Therefore, the overall control unit 119 adjusts the transmittance control information 131, in other words, the control amount, to the variable optical attenuator 104 while returning to step S1203 until the size of the foreign matter falls within the allowable error range (step S1206). By using such a flow, the laser power can be calibrated.

### Main Effects of Embodiment 7

As described above, by using the method according to Embodiment 7, the effects same as those described in Embodiment 1 or Embodiment 5 can be obtained. Further, the laser power can be calibrated when the laser power fluctuates due to a change over time, an environmental change, or the like. In particular, even when a fluctuation occurs in the characteristics of the laser power monitors 109a to 109c as illustrated in Embodiments 2 to 4, the fluctuations can be corrected.

### Other Embodiments

For example, in Embodiment 1, the variable optical attenuator 104 is assumed to have a single stage configuration including an electro-optical element and a polarization beam splitter, but the variable optical attenuator 104 may be provided in a plurality of stages, or a plurality of voltage levels may be applied to the electro-optical element, such that the laser beam 130b can be switched between a plurality of levels (power). Since the laser power monitor 109 can acquire a plurality of levels of laser power, the gain correction unit 114 can correct a detection signal from the optical sensor 111 by an operation same as the operation described in Embodiment 1.

Although the invention has been specifically described above based on embodiments, the invention is not limited to the above-described embodiments, and various modifications can be made without departing from the scope of the invention. Components of the embodiments can be added, deleted, replaced, or the like except for essential components. The embodiments can be combined. Unless otherwise specified, each component may be single or plural. Various media such as a ROM, a RAM, a nonvolatile memory, an HDD, an SSD, a DVD, and an SD card can be used to store various kinds of data.

### REFERENCE SIGNS LIST

100 sample
101 rotation stage
102 translation stage
103 laser light source
104 variable optical attenuator
107 optical sensor
108 laser power control unit
109 laser power monitor
111 optical sensor
112 A/D conversion circuit
113 large foreign matter determination unit
114 gain correction unit
115 data processing unit
116 image generation unit
117 coordinate detection unit
118 stage control unit
119 overall control unit
195 controller

1. An optical-type foreign matter inspection device for inspecting a foreign matter on a surface of a sample, the optical-type foreign matter inspection device comprising:
a rotation stage configured to allow the sample to be placed thereon and rotate the sample;
a laser light source configured to irradiate the surface of the sample with a laser beam;
a variable optical attenuator configured to adjust laser power of the laser beam with which the surface of the sample is irradiated by being inserted in an optical path of the laser beam;
a first optical sensor configured to receive the laser beam transmitted through the variable optical attenuator and output a first detection signal according to a received light amount;
a laser power monitor configured to measure, based on the first detection signal, the laser power applied to the surface of the sample;
a second optical sensor configured to receive light scattered or reflected from the surface of the sample and output a second detection signal according to a received light amount; and
a controller configured to control the optical-type foreign matter inspection device, wherein
the controller
determines, based on the second detection signal, presence or absence of a large foreign matter exceeding a predetermined size,
reduces the laser power using the variable optical attenuator when it is determined that the large foreign matter is present, and
corrects, based on a measurement value of the laser power by the laser power monitor, the second detection signal within a reduction period of the laser power.

2. The optical-type foreign matter inspection device according to claim 1, wherein
the laser light source has a pulsed laser type configuration that outputs a pulse in synchronization with a laser oscillation clock,
the laser power monitor includes
a plurality of A/D conversion circuits that sample the first detection signal according to a sampling clock and convert the first detection signal into digital data,
a phase adjustment circuit that generates a plurality of the sampling clocks having different phases by adjusting a phase of the received input laser oscillation clock, and outputs each of the plurality of sampling clocks to a respective one of the plurality of A/D conversion circuits, and
a difference calculation circuit,
the plurality of A/D conversion circuits each include
a peak detection A/D conversion circuit that detects a peak value according to the sampling clock having a phase near a peak value of the first detection signal, and
a bottom detection A/D conversion circuit that detects a bottom value according to the sampling clock having a phase near a bottom value of the first detection signal, and
the difference calculation circuit calculates, as the measurement value of the laser power, a difference value between the peak value detected by the peak detection A/D conversion circuit and the bottom value detected by the bottom detection A/D conversion circuit.

3. The optical-type foreign matter inspection device according to claim 2, wherein the laser power monitor further includes a maximum value selection circuit and a minimum value selection circuit,
the peak detection A/D conversion circuit and the bottom detection A/D conversion circuit are each provided in two or more,
the two or more peak detection A/D conversion circuits receive the sampling clocks having different phases near the peak value of the first detection signal,
the two or more bottom detection A/D conversion circuits receive the sampling clocks having different phases near the bottom value of the first detection signal,
the maximum value selection circuit selects a maximum value from peak values detected by the two or more peak detection A/D conversion circuits,
the minimum value selection circuit selects a minimum value from bottom values detected by the two or more bottom detection A/D conversion circuits, and
the difference calculation circuit calculates a difference value between the maximum value and the minimum value as the measurement value of the laser power.

4. The optical-type foreign matter inspection device according to claim 1, wherein
the laser light source has a pulsed laser type configuration that outputs a pulse in synchronization with a laser oscillation clock, and
the laser power monitor includes
a peak detection circuit that detects a peak voltage of the first detection signal,
a bottom detection circuit that detects a bottom voltage of the first detection signal,
a difference detection circuit that detects a difference voltage between the peak voltage and the bottom voltage, and
an A/D conversion circuit that samples the difference voltage from the difference detection circuit according to the laser oscillation clock, converts the difference voltage into digital data, and outputs the digital data as the measurement value of the laser power.

5. The optical-type foreign matter inspection device according to claim 1, wherein
the laser light source has a pulsed laser type configuration that outputs a pulse in synchronization with a laser oscillation clock, and
the laser power monitor includes
an A/D conversion circuit that samples the first detection signal with a sampling clock having a frequency twice or more higher than that of the laser oscillation clock and converts the first detection signal into digital data,
an interval division circuit that divides the digital data from the A/D conversion circuit for each data group for one period based on the laser oscillation clock,
a maximum value selection circuit that selects a maximum value from the data group for one period,
a minimum value selection circuit that selects a minimum value from the data group for one period, and
a difference calculation circuit that calculates, as the measurement value of the laser power, a difference value between the maximum value and the minimum value.

6. The optical-type foreign matter inspection device according to claim 1, wherein
the controller corrects the second detection signal by multiplying the second detection signal by a reciprocal of the measurement value of the laser power.

7. The optical-type foreign matter inspection device according to claim 1, wherein
the controller
stores a previously known time response characteristic of the second optical sensor,
calculates a reflected measurement value by reflecting the time response characteristic of the second optical sensor in the measurement value of the laser power, and
compensates for a relative delay between the second detection signal and the reflected measurement value, and then corrects the second detection signal by multiplying the second detection signal by a reciprocal of the reflected measurement value.

8. The optical-type foreign matter inspection device according to claim 1, wherein
the variable optical attenuator includes a plurality of stages.

9. The optical-type foreign matter inspection device according to claim 1, wherein
the variable optical attenuator includes an electro-optical element and a polarization beam splitter.

10. An optical-type foreign matter inspection device for inspecting a foreign matter on a surface of a sample, the optical-type foreign matter inspection device comprising:
a rotation stage configured to allow the sample to be placed thereon and rotate the sample about a rotation axis;
a translation stage configured to move the rotation stage within a horizontal plane with the rotation axis as a vertical direction;
a laser light source configured to irradiate the surface of the sample with a laser beam;
a variable optical attenuator configured to adjust laser power of the laser beam with which the surface of the sample is irradiated by being inserted in an optical path of the laser beam;
a first optical sensor configured to receive the laser beam transmitted through the variable optical attenuator and output a first detection signal according to a received light amount;
a laser power monitor configured to measure the laser power with which the surface of the sample is irradiated based on the first detection signal;
a second optical sensor configured to receive light scattered or reflected from the surface of the sample and output a second detection signal according to a received light amount; and
a controller configured to control the optical-type foreign matter inspection device, wherein
the controller
stores, as control information, a setting value of the laser power for each coordinate within the horizontal plane in the translation stage and a control amount of the variable optical attenuator,
controls, based on the control information, the laser power using the control amount of the corresponding variable optical attenuator for each coordinate within the horizontal plane, and
calculates, for each coordinate within the horizontal plane, an error between a measurement value of the laser power that is measured by the laser power monitor and the setting value of the laser power in the control information, and corrects a control amount of the variable optical attenuator in the control information based on the calculated error.

11. The optical-type foreign matter inspection device according to claim 10, wherein
the laser light source has a pulsed laser type configuration that outputs a pulse in synchronization with a laser oscillation clock,
the laser power monitor includes
a plurality of A/D conversion circuits that sample the first detection signal according to a sampling clock and convert the first detection signal into digital data,
a phase adjustment circuit that generates a plurality of the sampling clocks having different phases by adjusting a phase of the received laser oscillation clock and outputs each of the plurality of sampling clocks to a respective one of the plurality of A/D conversion circuits, and
a difference calculation circuit,
the plurality of A/D conversion circuits each include
a peak detection A/D conversion circuit that detects a peak value according to the sampling clock having a phase near a peak value of the first detection signal, and
a bottom detection A/D conversion circuit that detects a bottom value according to the sampling clock having a phase near a bottom value of the first detection signal, and
the difference calculation circuit calculates, as the measurement value of the laser power, a difference value between the peak value detected by the peak detection A/D conversion circuit and the bottom value detected by the bottom detection A/D conversion circuit.

12. The optical-type foreign matter inspection device according to claim 10, wherein
the laser light source has a pulsed laser type configuration that outputs a pulse in synchronization with a laser oscillation clock, and
the laser power monitor includes
a peak detection circuit that detects a peak voltage of the first detection signal,
a bottom detection circuit that detects a bottom voltage of the first detection signal,
a difference detection circuit that detects a difference voltage between the peak voltage and the bottom voltage, and
an A/D conversion circuit that samples the difference voltage from the difference detection circuit according to the laser oscillation clock, converts the difference voltage into digital data, and outputs the digital data as the measurement value of the laser power.

13. The optical-type foreign matter inspection device according to claim 10, wherein
the laser light source has a pulsed laser type configuration that outputs a pulse in synchronization with a laser oscillation clock, and
the laser power monitor includes
an A/D conversion circuit that samples the first detection signal with a sampling clock having a frequency twice or more higher than that of the laser oscillation clock and converts the first detection signal into digital data,
an interval division circuit that divides the digital data from the A/D conversion circuit for each data group for one period based on the laser oscillation clock,
a maximum value selection circuit that selects a maximum value from the data group for one period,
a minimum value selection circuit that selects a minimum value from the data group for one period, and
a difference calculation circuit that calculates, as the measurement value of the laser power, a difference value between the maximum value and the minimum value.

14. The optical-type foreign matter inspection device according to claim 10, wherein
the controller
stores, as a master value, the measurement value of the laser power measured using the laser power monitor under a predetermined condition when creating a reference value for use in device calibration, and
compares the measurement value of the laser power measured using the laser power monitor under the predetermined condition with the master value at any calibration timing, and corrects a gain of the laser power monitor or the control amount of the variable optical attenuator that is included in the control information when an error between the measurement value of the laser power and the master value is out of an allowable range.

15. The optical-type foreign matter inspection device according to claim 10, wherein
the variable optical attenuator includes a half-wave plate and a polarization beam splitter.
